(19) United States
(12) Patent Application Publication
(10) Pub. No.: US 2006/0250255 A1
(43) Pub. Date: Nov. 9, 2006

(54) Paired child to parent separation distance monitoring and alarm system and method of same

(76) Inventor: Eugene Edward Flanagan, Unionville, VA (US)

Correspondence Address: Galasso & Associates, LP, P.O. Box 26503, Austin, TX, 78755-0503, US

(21) Appl. No.: 11/417,392

(22) Filed: May 3, 2006

Related U.S. Application Data
(60) Provisional application No. 60/678,485, filed on May 6, 2005.

(51) Int. Cl. G08B 1/08

(52) U.S. Cl. 340/573.4; 340/539.15

(57) ABSTRACT

A child safety system in the form of a parent to child separation distance monitoring and alarm system is provided comprising a small size wireless radio frequency proximity monitor transmitter worn by a child and a wireless separation distance monitoring receiver and alarm, the receiver intended to be worn or carried by a parent or guardian of the child. The transmitter is configured to be attached to the infant seat strap, clothing strap, belt or other article of clothing worn by the child. In certain embodiments the alarm system is provided with signal discrimination and false trigger reduction capabilities.

### CROSS REFERENCE TO RELATED APPLICATIONS

This application claims priority to co-pending U.S. Provisional Patent Application having Ser. No. 60/678,485 filed May 6, 2005 entitled “Will B Safe” having a common applicant herewith.

### FIELD OF THE DISCLOSURE

The disclosures made herein relate generally to proximity detectors and proximity monitoring systems and more particularly to devices for monitoring the distance separating a wearable transmitter from a wearable or carried receiver where the transmitter is worn by a child and the receiver is configured to monitor the separation distance between the child and parent and to warn the parent when the separation distance exceeds a configured limit.

### BACKGROUND

Parents with young children are always concerned with the safety of their children. When a parent takes a child along on a shopping trip or out to a public place, the parent typically wishes to give the child some degree of free reign to walk, explore and experience the surroundings. It is of the utmost importance to the parent and to the safety of the child that the parent always keeps the child within a close range of distance where the child can be watched over and protected from dangers or from wandering too far from the parent and becoming lost.

Additionally, when in a crowd with young children, there is the risk of child abduction. Everything from news reports to milk cartons carries pictures and descriptions of missing children. When a parent is out in public with their child, the child can easily be distracted and curiosity and the trusting nature of youth can take over leading the child to wander away from parents to explore the bright lights, favorite toys, flashy displays or most anything exciting that draws the attention of the child.

Therefore, a child safety parent to child separation distance monitoring system that warns the parent when a child has wandered off by more than a configured distance, a system that can be used in circumstances when the child is not in a direct line of sight of the parent, a system that includes features to minimize false alarm trips, a system having a transmitter that is small and easily attachable to the clothing of a child, a system that is configured to detect, identify and isolate the signal of the child's proximity monitor transmitter from potentially many other similar child monitoring transmitter devices within range or other spurious radio frequency noise signals, such a parent to child separation distance monitoring system would be useful and novel.

### SUMMARY OF THE DISCLOSURE

Accordingly, embodiments of the inventive disclosures made herein comprise various embodiments of a child safety system in the form of a parent to child separation distance monitoring and alarm system.

In one embodiment of the inventive disclosures made herein, a parent to child separation distance monitoring system comprises a small size wireless radio frequency child proximity monitor transmitter device and a wireless separation distance monitoring receiver and alarm, the receiver intended to be worn or carried by a parent or guardian of the child and the transmitter worn by the child.

The wireless proximity monitoring transmitter is configured to be attached to the seat strap of an infant seat or to a clothing strap, belt or other article of clothing worn by the child. The transmitter device has a substantially rectangular housing. The front of the housing is provided with a battery condition monitoring indicator in the form of an indicator light. The battery condition indicator is preferably a light emitting diode indicator that remains illuminated or flashes intermittently to acknowledge to the parent that the battery condition is sufficient to operate the transmitter device. The indicator light extinguishes when the battery power drops to a level where the battery should be replaced or charged within a near period of time. The rear of the transmitter housing has a flexible strap secured at a top end to the rear face of the housing, the strap having a conventional fabric hook and loop attachment means on the opposite end of the strap. The hook and loop attachment means on the strap mates with a complimentary hook and loop patch secured to the rear face of the transmitter. The strap is sized to latchably secure the transmitter to a child infant seat seatbelt, or to a strap, belt or article of clothing worn by the child. The transmitter means comprises a means of transmitting a periodically repeating radio frequency signal, the signal strength used by separation distance receiver of the parent to gauge the separation distance between the transmitter and receiver, which is the separation distance between the child and parent or guardian.

And now to focus on the parent's proximity monitoring receiver. The wireless radio frequency proximity monitoring receiver for a parent or guardian comprises a substantially rectangular housing having a front face having a first hole and a second hole, an opposing rear face, and periphery side faces. The housing is similar in size and shape to the housing of the proximity monitoring transmitter. The receiver has a key ring attached to the housing such that the receiver can serve as a key ring holder or key fob. The receiver comprises a battery for providing electrical power to the receiver device, an alarm speaker secured behind the front face or the speaker for generating an audible warning to the parent or guardian. Similar to the child transmitter, the receiver is equipped with a battery condition monitor having an indicator lamp secured to the front of the housing and visible from the front of the housing. The proximity monitoring receiver includes a means for receiving the periodically transmitted signal from the child proximity monitoring transmitter and processing said transmitted repeating radio signal to determine when the child transmitter is beyond a configured distance from the parental receiver. The receiver includes a means of generating an alarm when the transmitter is beyond the configured distance from the receiver so as to warn the parent or guardian. The alarm means drive the speaker to produce the audible warning.

In a second embodiment the above parent to child separation distance monitoring system is modified to set the configured maximum separation distance between the child and parent at 14 feet, beyond which an alarm is generated on the receiver.

A third embodiment of the inventive disclosures made herein, a parent to child separation distance monitoring system is provided having signal discrimination and false trigger reduction capabilities. The system comprises a small size wireless radio frequency child proximity monitor transmitter device and a wireless separation distance monitoring receiver and alarm. As described above, the receiver intended to be worn or carried by a parent or guardian of the child.

As in the first embodiment, the wireless proximity monitoring transmitter of the third embodiment is configured to be attached to the infant seat strap, clothing strap, belt or other article of clothing worn by the child. The transmitter device has a substantially rectangular housing. The front of the housing is provided with a battery condition monitoring indicator in the form of an indicator light. The battery condition indicator is preferably a light emitting diode indicator that remains illuminated or flashes intermittently when the battery condition is sufficient to operate the transmitter device for a reasonable period of time. The indicator light extinguishes when the battery power drops to a level where the battery should be replaced or charged within a reasonable amount of time. The rear of the transmitter housing has a flexible strap secured at a top end to the rear face of the housing, the strap having conventional fabric hook and loop attachment means on the opposite end of the strap. The hook and loop attachment means on the strap mates with a complimentary hook and loop patch secured to the rear face of the transmitter. The strap is sized to latchably secure the transmitter to a child infant seatbelt or to a strap, belt or article of clothing worn by the child.

The transmitter device of the third embodiment includes elements and features to provide a unique one to one identification between the transmitted signal and the transmitter, wherein each child transmitter manufactured of this type has a unique identification code assigned to it and wherein the identification code is transmitted on the periodically transmitted radio frequency carrier signal. The unique identification code comprises a binary code unique to each child proximity transmitter, wherein each transmitter can be uniquely recognized by its binary code by the receiver. The transmitter of this embodiment includes a timer means for triggering periodic transmission of a radio frequency signal at a fixed transmission time interval, this fixed periodicity is also used by the receiver to know when to look for or expect the next transmission. The transmitter generates and transmits a radio frequency signal carrying the binary code in response to the periodic timer trigger.

Furthermore, the third embodiment of the inventive disclosures made herein includes a wireless radio frequency child parent separation distance monitoring receiver for a parent or guardian, the receiver having signal discrimination and false trigger reduction capabilities. The wireless radio frequency proximity monitoring receiver for a parent or guardian comprises a substantially rectangular housing having a front face having a first hole and a second hole, an opposing rear face, and periphery side faces. The housing is similar in size and shape to the housing of the proximity monitoring transmitter. The receiver has a key ring attached to the housing such that the receiver can serve as a key ring holder or key fob. The receiver comprises a battery for providing electrical power to the receiver device, an alarm speaker secured behind the front face or the speaker for generating an audible warning to the parent or guardian. The receiver is equipped with a battery condition monitor having an indicator lamp secured to the front of the housing and visible from the front of the housing. The proximity monitoring receiver comprises a receiver means for receiving the periodic radio frequency signal from the transmitter device worn by the child. The receiver includes a storage means having the assigned unique binary code of the paired child transmitter stored therein. Received signals are then first passed to a signal binary discriminator means connected to an output of said receiver means, the binary discriminator means compares the received binary code, if any, in the received signal against the paired binary code and discards received signals that do not match the paired binary code in the storage means. In this way the receiver is not confused by stray signals, or signals from other child proximity transmitters of other parents. The discriminator means has a signal strength output and a trigger output. The receiver includes a signal strength low limit reference means which provides a reference signal strength establishing the maximum permitted distance between transmitter and receiver before an alarm is generated. The receiver includes the following additional means of reducing the occurrence of false alarm trips. A low signal occurrence counter means is provided that counts the number of consecutive occurrences of low received signal strength from child proximity transmitter, wherein a low received signal indicates the separation distance between the child and parent is greater than configured maximum distance. Before an alarm is generated, two or more consecutive low signal occurrences must occur in succession, the number of consecutive occurrences before alarm is configured into the receiver. This retry feature allows obstructions that may occur between the parent and child that affect signal strength to clear before an alarm is generated, thereby reducing the number of false alarm trips and resulting in a more robust proximity alarm system. This retry count is configurable in the receiver by the parent or guardian. Additionally, to reduce false trips, the receiver further includes a periodic timer means having a time period substantially matching the transmission time period of the child transmitter. The periodic timer is used to increment a count of the elapsed time since the child transmitter has been detected as within the configured separation distance of the receiver. The elapsed time counter handling occurrences when the child transmitter signal may be momentarily blocked by spurious radio frequency interference or by a conductive metallic shielding obstacle between the parent and child, thereby allowing a little additional time to verify the child is out of range before generating an alarm to the parent. This elapsed time limit also being configurable on the parent's proximity monitoring receiver.

In a fourth embodiment the receiver of the third embodiment is modified to set the configured maximum separation distance between the child and parent at 14 feet, beyond which an alarm is generated on the receiver.

It is an objective of the inventive disclosure made herein to provide a child parent separation monitoring system that warns a parent or guardian when a child has wandered away from the parent by more than a configured distance.

It is another objective of the inventive disclosure made herein to provide a child parent separation monitoring system that can be used in circumstances when the child is not in a direct line of sight from the parent.

It is another objective of the inventive disclosure made herein to provide a child parent separation monitoring system that includes features to minimize false alarm trips.

It is another objective of the inventive disclosure made herein to provide a child parent separation monitoring system that includes a transmitter that is small and easily attachable to the clothing of a child.

It is another objective of the inventive disclosure made herein to provide a child parent separation monitoring system that is configured to detect, identify and isolate the signal from the child's proximity monitor transmitter from potentially many other similar child monitoring transmitter devices within range or other spurious radio frequency noise, such as to prevent radio frequency noise from causing the lack of an alarm signal to the parent when an alarm should be generated.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 presents a perspective view of one embodiment of a child parent separation monitor and alarm in accordance with the inventive disclosures herein.

FIG. 2 presents a perspective view of the front of one embodiment of a child monitor transmitter in accordance with the inventive disclosures herein.

FIG. 3 presents a perspective view of the rear side and strap of one embodiment of a child monitor transmitter in accordance with the inventive disclosures herein.

FIG. 4 presents a block diagram of a child monitor transmitter in accordance with the inventive disclosures herein.

FIG. 5 presents a block diagram of a child parent separation monitor and alarm in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

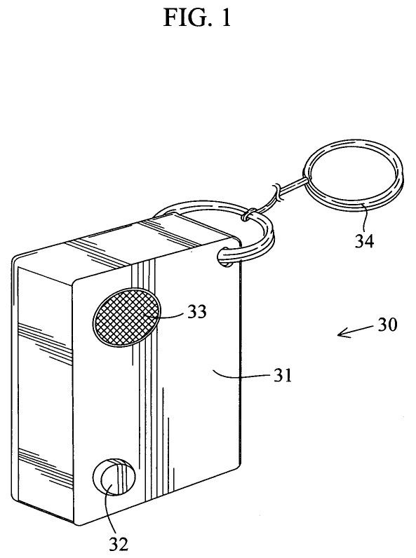

FIG. 1 presents a front perspective view of one embodiment of a child parent separation monitor receiver and alarm in accordance with the inventive disclosures herein. The monitor receiver device 30 has a substantially rectangular housing. The front of the housing 31 is provided with a battery condition monitoring indicator 32 in the form of an indicator light. The battery condition indicator is preferably a light emitting diode indicator that remains illuminated or flashes intermittently when the battery condition is sufficient to operate the receiver device for an extended period. The indicator light extinguishes when the battery power drops to a level where the battery should be replaced or charged within a reasonable period of time. An alarm speaker 33 or other audible annunciation device is provided on the front 31 of the enclosure. The receiver has a key ring 34 attached to the housing such that the receiver can server as a key ring holder or key fob.

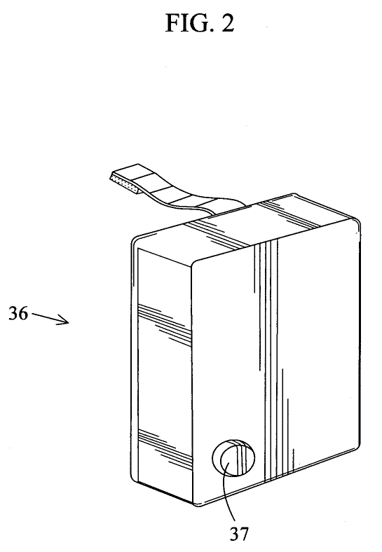

FIG. 2 presents a perspective view of the front of one embodiment of a child monitor transmitter 36 in accordance with the inventive disclosures herein. The wireless proximity monitoring transmitter is configured to be attached to the infant seat strap, clothing strap, belt or other article of clothing worn by the child. The transmitter device has a substantially rectangular housing. The front of the housing is provided with a battery condition monitoring indicator 37 in the form of an indicator light. The battery condition indicator is preferably a light emitting diode indicator that remains illuminated or flashes intermittently when the battery condition is sufficient to operate the transmitter device. The indicator light extinguishes when the battery power drops to a level where the battery should be replaced or charged.

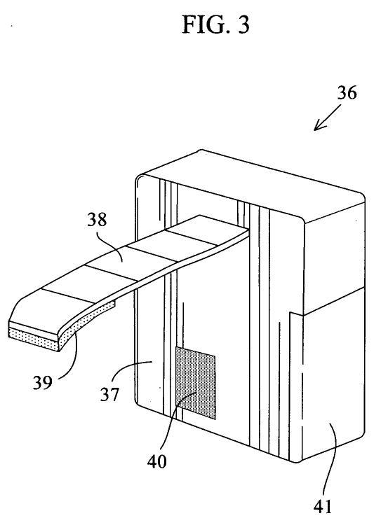

FIG. 3 presents a perspective view of the rear side and strap of one embodiment of a child monitor transmitter in accordance with the inventive disclosures herein. The rear 37 of the transmitter housing has a strap 38 secured at a top end to the rear face 37 of the housing, and having conventional fabric hook and loop attachment means 39 on the opposite end of the strap. The hook and loop attachment means on the strap mating with a complimentary hook and loop patch 40 secured to the rear face of the transmitter. The strap 38 is sized to latchably secure the transmitter to a child infant seat seatbelt or to a strap, belt or article of clothing work by the child. A battery compartment door 41 is shown on the side of the housing.

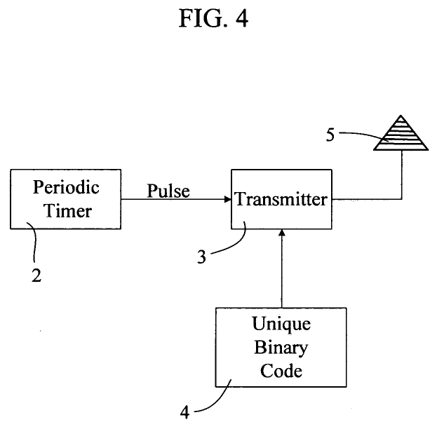

FIG. 4 presents a block diagram of a child monitor transmitter in accordance with the inventive disclosures herein. The transmitter includes a periodic timer 2, which at regular and fixed intervals sends a trigger pulse to the transmitter 3. When the transmitter receives the pulse it generates a radio frequency carrier signal having encoded thereon the unique binary code of the child transmitter, the unique binary code uniquely identifying the child transmitter from other radio frequency devices and child transmitters that may be in the area. The radio frequency carrier is sent to the internal antenna 5 for broadcast to the parent monitor and alarm.

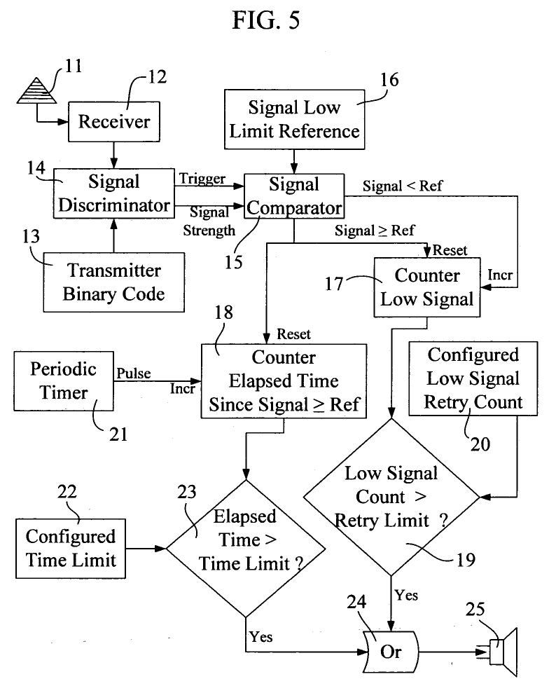

FIG. 5 presents a block diagram of a child parent separation monitor and alarm receiver in accordance with the inventive disclosures herein. Antenna 11 carries radio frequency signals to the receiver 12 which serves as a band pass filter and RF signal amplifier, potentially with signal mixing to a lower intermediate frequency for more efficient signal amplification. The received signal is passed to a discriminator 14 which passes only signals having the binary code 13 of the paired transmitter, other signals and noise being ignored or discarded. When a signal is received at the discriminator 14 matching the binary code 13, signal strength information and a trigger signal is passed to the signal comparator 15. The signal comparator 15 compares the received signal strength against a configured signal low limit reference 16 which establishes the maximum permitted separation distance between the child transmitter and parent receiver. If the received signal strength is greater than the reference, indicating the child to parent separation distance is less than the configured maximum of the low limit reference, then the comparator sends a reset signal to the low signal counter 17 and elapsed time signal counter 18. If the received RF signal is less than the low limit reference, indicating the child may be beyond the configured separation distance, then the signal comparator 15 outputs an increment pulse to the low signal counter 17 which counts the number of consecutive occurrences a low signal strength condition has been detected. The low signal count is compared to a configured low signal retry count setting 20 at block 19, and if the low signal count exceeds the retry count then alarm 25 is initiated by a signal sent through the ‘or’ gate 24 to the audible alarm means 25. The above described retry count reduces occurrences of false triggers, and importantly the retry count is configurable by the parent or guardian. Periodic timer 21 issues a pulse at defined time increments to the elapsed time counter 18. The time period of the timer 21 substantially matches the time period of the child monitor transmitter pulse timer. The pulse from the timer 21 periodically increments the elapsed time counter 18. Elapsed time counter 18 is reset every time the detected child monitor RF signal has a signal strength greater than the low limit reference detected by the comparator 15, which means it should reset to zero every time the child's monitor transmitter is detected and is known to be within the configured range of separation. In such cases the elapsed time counter would contain a 0 or a 1 during normal operation. The value of the elapsed time counter 18 is compared to a user configured time limit 22 in decision block 23. In block 23 if the child is not detected as within configured maximum distance separation range for within the last user configurable time period, then block 23 initiates an alarm by sending a signal through ‘or’ block 24 to the audible alarm means 25.

The discussed construction, illustrations and sequence of operation is for one embodiment of the invention but is in no way limiting to other embodiments. The operating modes may be changed and enhanced without deviating from the intention of this inventive disclosure.

In the preceding detailed description, reference has been made to the accompanying drawings that form a part hereof and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, electrical, electronic and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents as can be reasonably included within the spirit and scope of the appended claims.

What is claimed is:

1. A paired child to parent separation distance monitoring alarm system comprising:
a child proximity monitor transmitter device, the device worn by a child, the transmitter device comprising:
a substantially rectangular housing having a front face having a hole, an opposing rear face, and periphery side faces;
a battery for providing electrical power to the transmitter device;
a battery condition monitor having an indicator lamp, the lamp secured behind the hole of the front face such as to be visible from outside the transmitter;
a flexible strap having a top end and a bottom portion joined to opposing ends of an intermediate strap portion, the top end secured to the rear face of the transmitter housing, the bottom portion having a first half of a paired means of removably latching the strap; and
a means of transmitting a periodically repeating radio frequency signal;
a proximity monitoring receiver for a parent, the receiver comprising:
a substantially rectangular housing having a front face having a first hole and a second hole, an opposing rear face, and periphery side faces;
a battery for providing electrical power to the receiver device;
an alarm speaker secured behind the second hole of the front face, the speaker for audibly warning the parent;
a battery condition monitor having an indicator lamp, the lamp secured behind the first hole of the front face such as to be visible from outside the receiver;
a key ring for holding a plurality of car and house keys, the key ring secured to the housing of the receiver;
a means for receiving and processing said transmitted repeating radio signal to determine when the transmitter is beyond a configured distance from the receiver; and
a means of generating an alarm when the transmitter is beyond the configured distance from the receiver, the alarm means connected to drive the speaker.

2. The paired separation distance monitoring alarm system of claim 1, wherein the configured distance is 14 feet.

3. The paired separation distance monitoring alarm system of claim 2, wherein the transmitter and receiver housings comprise plastic, each housing having dimensions of 1½ inches long by 1 inch in width by ½ inch thick.

4. A paired child to parent separation distance monitoring alarm system having signal discrimination and false trigger reduction capabilities, the system comprising:
a child monitor proximity transmitter device, the device worn by a child, the transmitter device comprising:
a substantially rectangular housing having a front face having a hole, an opposing rear face, and periphery side faces;
a timer means for triggering periodic transmission of a radio frequency signal at a fixed transmission time interval;
a binary code unique to each child proximity transmitter, wherein each transmitter can be uniquely recognized by its binary code;
a means for generating the radio frequency signal carrying the binary code in response to the timer trigger;
a means for transmitting the radio frequency signal over a distance;
a battery for providing electrical power to the transmitter device;
a battery condition monitor having an indicator lamp, the lamp secured behind the hole of the front face such as to be visible from outside the transmitter;
a flexible strap having a top end and a bottom portion joined to opposing ends of an intermediate strap portion, the top end secured to the rear face of the transmitter housing, the bottom portion having a first half of a paired means of removably latching the strap;
a second half of the paired means for removably latching the strap secured to the rear face of the transmitter, wherein the strap when latched is sized for supportively capturing a belt or child clothing strap between the transmitter strap and the rear face of the transmitter such as to support the transmitter;
a proximity monitoring receiver, the receiver comprising:
a substantially rectangular housing having a front face having a first hole and a second hole, an opposing rear face, and periphery side faces;
a key ring for holding a plurality of car and house keys, the key ring secured to the housing of the receiver;
a receiver means for receiving said periodic radio frequency signal from said transmitter device;
a battery for providing electrical power to the receiver device;
a battery condition monitor having an indicator lamp, the lamp secured behind the first hole of the front face such as to be visible from outside the receiver;
an alarm speaker secured behind the second hole of the front face, the speaker for audibly warning the parent;
a storage means having the unique binary code of the paired transmitter;
a signal binary discriminator means connected to an output of said receiver means, the binary discriminator means comparing received binary code in the received signal against the paired binary code, the discriminator means discarding received signals not matching the paired codes, the discriminator having a signal strength output and a trigger output;
a signal strength low limit reference means, wherein the signal strength low limit establishes the proximity distance setting of maximum permitted distance between transmitter and receiver;
a signal strength comparator means for comparing the signal strength from the discriminator against the configured signal low limit reference, the signal comparator having two outputs, a first output asserted when the received signal is less than the low limit reference, and a second output asserted when the received signal strength is greater or equal to the low limit reference;
a low signal occurrence counter means having an increment input connected to the first output of the signal strength comparator, and a reset input connected to the second output of the signal strength comparator, wherein the counter counts consecutive occurrences of low received signal strength from transmitter, the low received signal indicating separation distance between the child and parent is potentially greater than configured maximum distance;
a low signal count comparator means for comparing the low occurrence count against a configured retry limit, the low signal count comparator having an output asserted when the low signal count is greater than the retry limit, wherein the retry limit reduces occurrences of false triggers by requiring multiple low signal occurrences before triggering an alarm;
a periodic timer means having a time period substantially matching the transmission time period of the transmitter, the periodic timer having a pulse output;
an elapsed time counter means having an increment input connected to the pulse output of the periodic timer and a reset input connected to the second output of the signal strength comparator, wherein the elapsed time counter means measures time elapsed since the transmitter was last shown to be within the configured maximum distance to the receiver;
an elapsed time comparator means for comparing the elapsed time counter against a configured time limit, the elapsed time comparator having an output asserted when the elapsed time is greater than the configured time limit, wherein the elapsed time comparator reduces false alarm triggers by requiring the received signal strength to be less than the signal low limit for an elapsed time period of two or more transmission time intervals before triggering an alarm;
an alarm means for alerting a parent or guardian to the child separation distance exceeding the configured distance range, the alarm means connected to and triggered by the output of the elapsed time comparator and the low signal count comparator, the alarm means connected to and driving the speaker.

5. The paired separation distance monitoring alarm system having signal discrimination and false trigger reduction capabilities of claim 4, wherein the transmitter and receiver housings comprise plastic, each housing having dimensions of 1½ inches long by 1 inch in width by ½ inch thick.

6. The paired separation distance monitoring alarm system having signal discrimination and false trigger reduction capabilities of claim 6, wherein the configured distance is 14 feet.

7. A method of implementing a paired child to parent separation distance monitoring alarm system having signal discrimination and false trigger reduction capabilities, the method comprising:
transmitting a repeating radio signal at a fixed periodicity, the signal transmitting a unique binary code corresponding to a transmitter worn by the child;
receiving the transmitted periodic signal on a monitoring receiver worn by the parent;
separating received paired transmitter signal from noise by binary code discrimination, wherein signals not containing and matching unique paired binary code are discarded;
comparing signal strength of the paired received signal strength against a low limit reference, wherein the low limit reference sets the maximum child to parent separation distance before an alarm is triggered;
accumulating a count of consecutive occurrences of received signal less than low limit reference, wherein the accumulated count resets when received signal is greater than the low limit reference;
generating an alarm when the number of low received signal occurrences is greater than a defined maximum, wherein false triggers are reduced by requiring multiple consecutive low signal levels detected before triggering an alarm;
counting elapsed time since the received signal was greater than or equal to the low limit;
generating an alarm when the elapsed time is greater than a defined time limit, wherein the defined time limit reduces false alarm triggers by requiring multiple low signal occurrences over a time period before alarm triggering.
